(19) United States
(12) Patent Application Publication
(10) Pub. No.: US 2012/0223869 A1
(43) Pub. Date: Sep. 6, 2012

(54) MICROSTRIP PATCH ANTENNA INCLUDING PLANAR METAMATERIAL AND METHOD OF OPERATING MICROSTRIP PATCH ANTENNA INCLUDING PLANAR METAMATERIAL

(75) Inventors: Dong Ho KIM, Daejeon (KR); Jae Geun Ha, Daegu (KR); Young Ki Lee, Jeju (KR); Young Sung Lee, Busan (KR); Jae Hoon Choi, Seoul (KR)

(73) Assignees: INDUSTRY-UNIVERSITY COOPERATION FOUNDATION HANYANG UNIVERSITY, Seoul (KR); ELECTRONICS AND TELECOMMUNICATIONS RESEARCH INSTITUTE, Daejeon (KR)

(21) Appl. No.: 13/179,140

(22) Filed: Jul. 8, 2011

(30) Foreign Application Priority Data
Mar. 2, 2011 (KR) 10-2011-0018336

(51) Int. Cl. H01Q 13/12; H01Q 5/01

(52) U.S. Cl. 343/769

(57) ABSTRACT

Provided is a microstrip patch antenna in which a unit cell of a planar metamaterial may be inserted to have a miniaturized size, a wide bandwidth, or multi-resonance.

### CROSS-REFERENCE TO RELATED APPLICATION

This application claims the benefit of Korean Patent Application No. 10-2011-0018336, filed on Mar. 2, 2011, in the Korean Intellectual Property Office, the disclosure of which is incorporated herein by reference.

### BACKGROUND

1. Field of the Invention

The present invention relates to a technology that may miniaturize an antenna and may extend a bandwidth, by greatly reducing a resonance frequency of the antenna.

2. Description of the Related Art

In early research, an antenna that may be operated in a zeroth-order resonance mode was developed using a unit cell of a metamaterial including a gap and a via hole, to have a resonance frequency independent of a size of the antenna.

A technology has currently reached a stage of miniaturizing the size of the antenna and configuring the antenna in a planar form, using a metal-insulator-metal (MTM) capacitor, a virtual ground inductor, and the like. Also, a broadband and a high gain may be achieved using a triangular gap, and a cross-shaped line. It is expected that the antenna may replace the existing antenna technology since the antenna may have a miniaturized size compared to an existing antenna structure, and also may have characteristics of the broadband and the high gain.

However, it may be difficult to commercialize the developed metamaterial antenna due to a complex manufacturing process, a narrow bandwidth, a low gain, and the like. Also, although antenna technologies have been developed to improve the aforementioned factors, it may also be difficult to use the antenna practically due to distortion of a radiation pattern.

### SUMMARY

An aspect of the present invention provides a microstrip patch antenna including a planar metamaterial having an isotropic radiation pattern as well as a wide bandwidth and a miniaturized size, in an operating frequency band.

Another aspect of the present invention also provides a microstrip patch antenna including a planar metamaterial having an antenna configuration where a unit cell of the metamaterial, including a complementary split-ring resonator (CSRR) slot and an interdigital capacitor, may be inserted in the microstrip patch antenna.

Another aspect of the present invention also provides a microstrip patch antenna that may change an operating frequency of an antenna, thereby miniaturizing the antenna, by matching impedance of the antenna by adjusting a size with respect to any of a radius, a width, a ring gap, and a ring split of the CSRR.

Another aspect of the present invention also provides a microstrip patch antenna including a planar metamaterial that may miniaturize an antenna, and may broaden a bandwidth of the antenna, by inserting a configuration of a unit cell of a metamaterial in the microstrip patch antenna, and by adjusting an operating frequency by adjusting a length of an inserted interdigital capacitor.

According to an aspect of the present invention, there is provided a microstrip patch antenna, including a patch disposed on an upper surface of a dielectric substrate, and a ground plane disposed on a lower part of the patch. Here, the patch may include an interdigital capacitor, and the ground plane may include a CSRR slot.

The patch may further include a microstrip feed line.

The patch may adjust an electrical size of the microstrip patch antenna, by adjusting a length of the interdigital capacitor.

The CSRR slot may adjust an operating frequency of the microstrip patch antenna, by adjusting a size with respect to any of a radius, a width, a ring gap, and a ring split.

The CSRR slot may match the impedance at the zeroth-order resonance, by adjusting a size with respect to any of a radius, a width, a ring gap, and a ring split.

The microstrip patch antenna may be controlled to be operated in a dual band, by adjusting a length of the interdigital capacitor, or a size with respect to any of a radius, a width, a ring gap, and a ring split of the CSRR slot.

The microstrip patch antenna may match impedance by adjusting a size of the patch.

The patch may apply both TM₀₁ and TM₁₀ mode simultaneously to the microstrip patch antenna, by adjusting a length of the interdigital capacitor.

The patch may combine two modes, each having a different frequency, by adjusting a length of the interdigital capacitor.

The patch may extend a bandwidth of the microstrip patch antenna, through the combination of the two modes.

The patch may enable the microstrip patch antenna to have an isotropic radiation pattern with respect to a horizontally polarized wave, through the combination of the two modes.

According to another aspect of the present invention, there is provided a method of operating a microstrip patch antenna, including configuring a patch disposed on an upper surface of a dielectric substrate, including an interdigital capacitor and a microstrip feed line, and configuring a ground plane disposed on a lower part of the patch, including a CSRR slot.

### EFFECT OF THE INVENTION

According to an embodiment of the present invention, a microstrip patch antenna may have an isotropic radiation pattern as well as a wide bandwidth and a miniaturized size, in an operating frequency band.

According to another embodiment of the present invention, a microstrip patch antenna may have an antenna configuration where a unit cell of a metamaterial, including a complementary split-ring resonator (CSRR) slot and an interdigital capacitor, may be inserted in the microstrip patch antenna.

According to another embodiment of the present invention, an antenna may be miniaturized and a bandwidth may be broadened by adjusting an operating frequency, by inserting a configuration of a unit cell of a metamaterial in a microstrip patch antenna, and by adjusting a length of an inserted interdigital capacitor.

According to another embodiment of the present invention, an antenna may be miniaturized by changing an operating frequency of the antenna, by matching impedance of the antenna by adjusting a size with respect to any of a radius, a width, a ring gap, and a ring split of the CSRR, thereby miniaturizing the antenna.

According to another embodiment of the present invention, an optimal impedance matching may be induced, by supporting a flexible adjustment of parameter values of a patch and a CSRR slot, with respect to multiple resonances caused by a characteristic of an inserted metamaterial.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a configuration of a microstrip patch antenna according to an embodiment of the present invention;

FIG. 2 illustrates a characteristic of impedance matching of a microstrip patch antenna according to a change in a size of a patch;

FIG. 3 illustrates a characteristic of impedance matching of a microstrip patch antenna according to a change in a size of a complementary split-ring resonator (CSRR) slot;

FIG. 4 illustrates a characteristic of impedance matching of a microstrip patch antenna according to a change in a size of parameters of a CSRR slot;

FIG. 5 illustrates an example of a change in a return loss of a microstrip patch antenna according to a change in a length of an interdigital capacitor;

FIG. 6 illustrates another example of a change in a return loss of a microstrip patch antenna according to a change in a length of an interdigital capacitor;

FIG. 7 illustrates electric field distribution of a microstrip patch antenna in modes, each having a different frequency;

FIG. 8 illustrates electric field distribution in a hybrid mode where two modes may be combined, according to a change in input phase;

FIG. 9 illustrates a characteristic of a return loss of an optimized microstrip patch antenna;

FIG. 10 illustrates three-dimensional (3D) radiation patterns of a microstrip patch antenna;

FIG. 11 illustrates a gain characteristic of a microstrip patch antenna; and

FIG. 12 illustrates a sequence of a method of operating a microstrip patch antenna according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

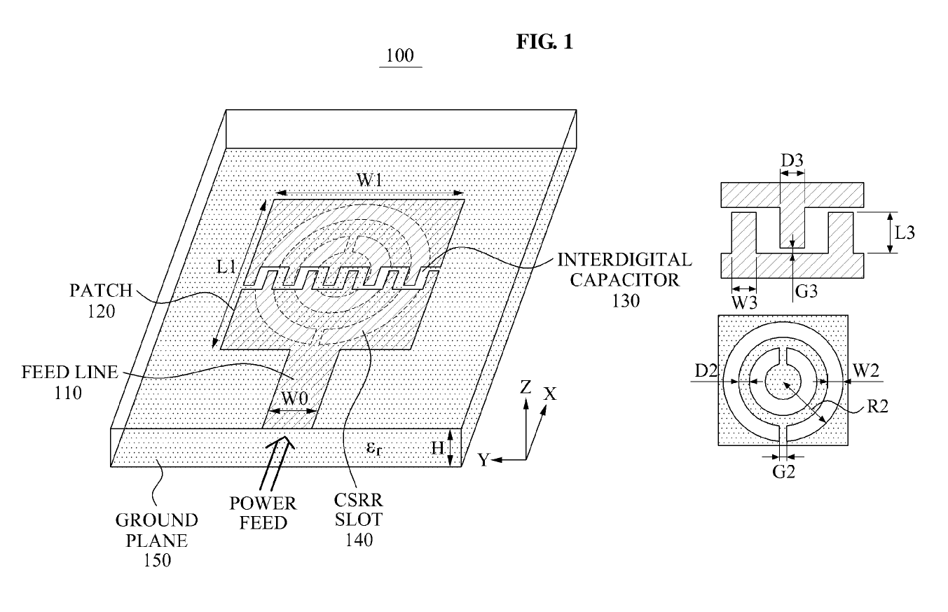

FIG. 1 illustrates a configuration of a microstrip patch antenna 100 according to an embodiment of the present invention.

Referring to FIG. 1, the microstrip patch antenna 100, which will be hereinafter referred to as an ‘antenna’ may include a microstrip feed line 110, a patch 120, an interdigital capacitor 130, a complementary split-ring resonator (CSRR) slot 140, and a ground plane 150.

On an upper surface of a dielectric substrate, the patch 120, which may be conductive and in which the microstrip feed line 110 and the interdigital capacitor 130 may be inserted, may be included. The patch 120 may adjust an electrical size of the antenna 100, by adjusting a length of the interdigital capacitor 130. For example, when a size of the patch 120 is fixed and the length of the interdigital capacitor 130 is increased, the antenna 100 may have increased series capacitance, and thus may have an effect of having an increased electrical size while the physical length may remain fixed.

The size of the patch 120, L1×W1, may be adjustable for impedance matching of the antenna 100. That is, an operating frequency of the antenna 100 may be changed when impedance of the antenna 100 is matched by adjusting the size of the patch 120. Generally, a width W0 of the microstrip feed line 110 may be determined to have characteristic impedance of the line corresponding to 50 Ω.

The ground plane 150, which may be conductive, may be disposed on a lower surface of the dielectric substrate, and the ground plane 150, in which the CSRR slot 140 may be inserted, may be disposed under the patch 120. A relative permittivity of a dielectric substance may correspond to εᵣ, and a dielectric substrate having a predetermined value may be used.

The CSRR slot 140 may adjust an operating frequency of the antenna 100, by adjusting a size with respect to any of a radius R2, a width W2, a ring gap D2, and a ring split G2 to optimum sizes.

For example, the radius R2 may correspond to 8 mm, the ring gap D2 may correspond to 1.5 mm, the width W2 may correspond to 2 mm, the ring split G2 may correspond to 1 mm, the length L1 of the patch 120 may correspond to 19 mm, the width W1 of the patch 120 may correspond to 19 mm, and the width WO of the microstrip feed line 110 may correspond to 5 mm.

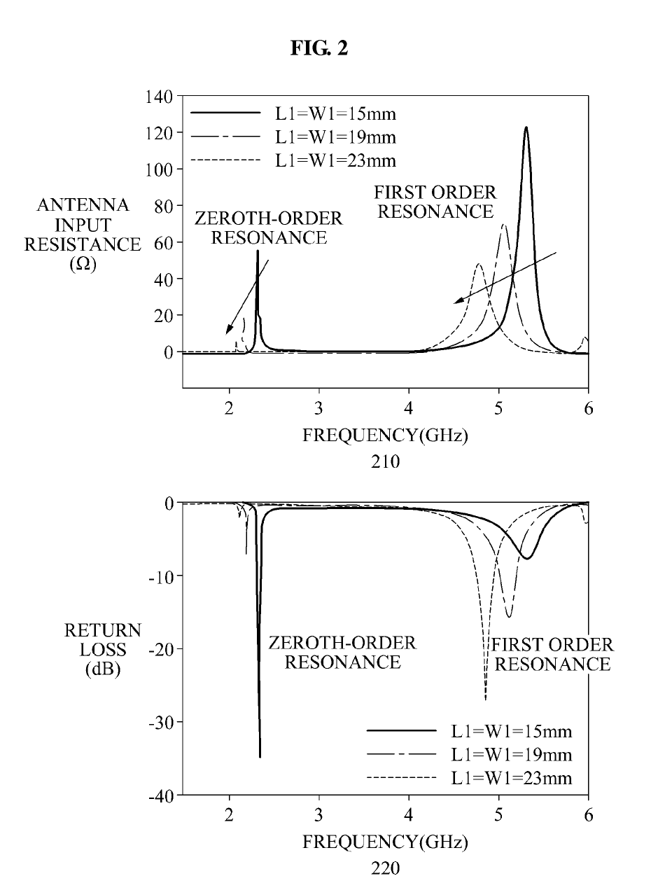

FIG. 2 illustrates a characteristic of impedance matching of a microstrip patch antenna according to a change in a size of a patch.

As illustrated in FIG. 2, a graph 210 may indicate input resistance, that is, impedance at a zeroth-order resonance frequency, and a first-order resonance frequency of the antenna 100, according to the length L1 and the width W1 of the patch 120. Also, a graph 220 may indicate a return loss at the zeroth-order resonance frequency, and the first-order resonance frequency of the antenna 100, according to the length L1 and the width W1 of the patch 120.

In FIG. 2, when an overall size of the patch 120 becomes greater, the overall impedance of the antenna 100 may be reduced. The antenna 100 may have a metamaterial characteristic, and accordingly may have a zeroth-order resonance, a first-order resonance, and the like. When the size of the patch 120 becomes greater, the impedance of the antenna 100 at the zeroth-order resonance, and the first-order resonance may be reduced. Accordingly, the impedance may be matched by tuning the size of the patch 120 and the size of parameters of the CSRR slot 140, for example, the radius R2, the width W2, the ring gap D2, and the ring split G2.

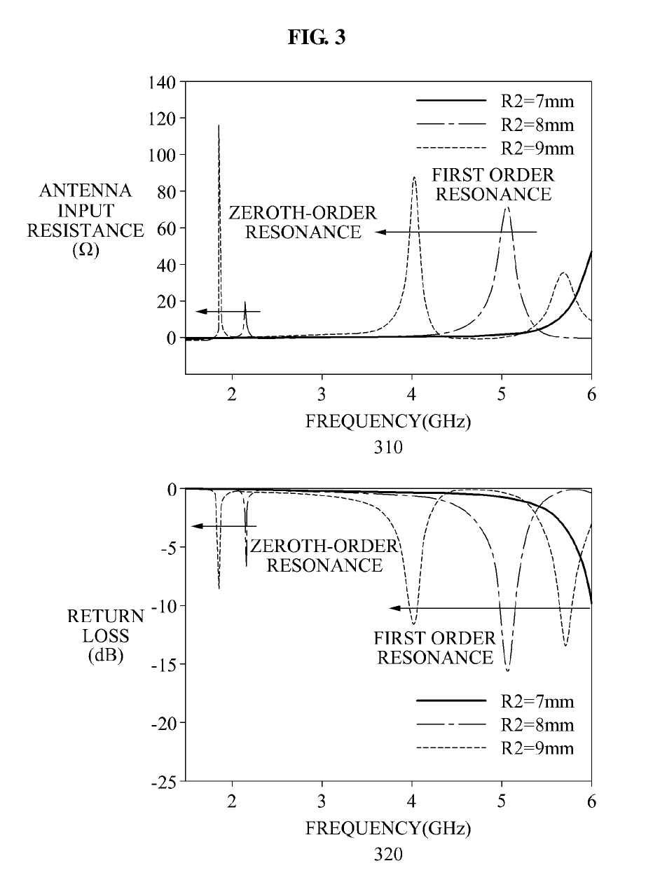

FIG. 3 illustrates a characteristic of impedance matching of a microstrip patch antenna according to a change in a size of a CSRR slot.

As illustrated in FIG. 3, when the radius R2 of the CSRR slot 140 becomes greater, an operating frequency of the antenna 100 including a zeroth-order resonance frequency, and a first-order resonance frequency may be reduced. A graph 310 may indicate input resistance at the zeroth-order resonance frequency, and the first-order resonance frequency of the antenna 100, according to a change in the radius R2 of the CSRR slot 140. Also, a graph 320 may indicate a return loss at the zeroth-order resonance frequency, and the first-order resonance frequency of the antenna 100, according to the change in the radius R2 of the CSRR slot 140.

It is because the operating frequency of the metamaterial antenna 100 may be unrelated to a physical size of the antenna 100, whereas the operating frequency of the metamaterial antenna 100 may be dependent on valid inductance and capacitance.

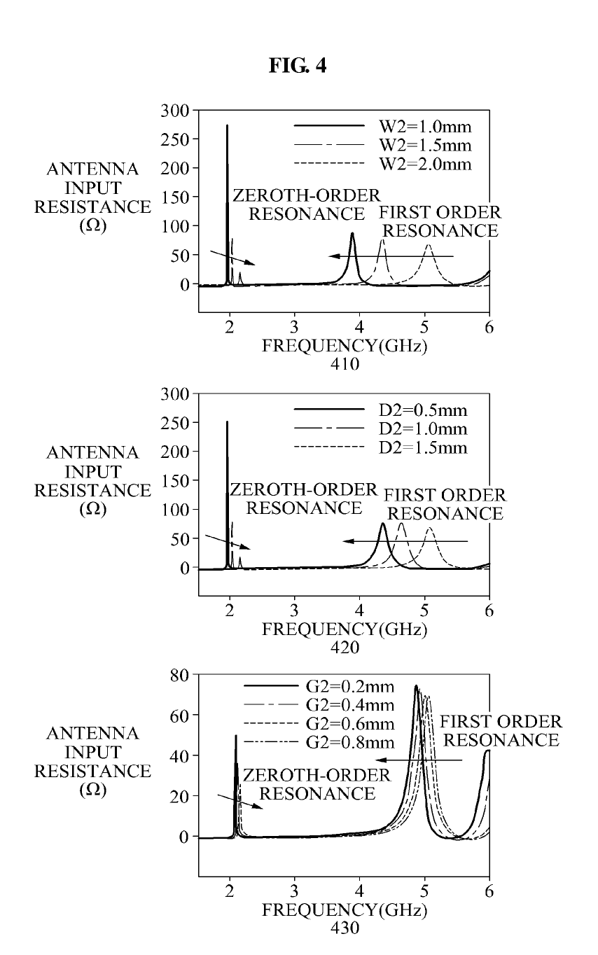

FIG. 4 illustrates a characteristic of impedance matching of a microstrip patch antenna according to a change in a size of parameters of a CSRR slot.

As illustrated in FIG. 4, the parameters of the CSRR slot 140 may correspond to the width W2, the ring gap D2, and the ring split G2. When the parameters are changed, an operating frequency and input impedance of the antenna 100 may be changed.

A graph 410 may indicate input resistance at the zeroth-order resonance frequency, and the first-order resonance frequency of the antenna 100, according to a change in the width W2 of the CSRR slot 140. A graph 420 may indicate input resistance at the zeroth-order resonance frequency, and the first-order resonance frequency of the antenna 100, according to a change in the ring gap D2 of the CSRR slot 140. Also, a graph 430 may indicate input resistance at the zeroth-order resonance frequency, and the first-order resonance frequency of the antenna 100, according to a change in the ring split G2 of the CSRR slot 140.

When the width W2, the ring gap D2, and the ring split G2 of the CSRR slot 140 become greater, input impedance of the antenna 100 may be reduced at the zeroth-order resonance frequency. Here, the antenna 100 may independently perform impedance matching at the zeroth-order resonance frequency. Also, as illustrated in FIG. 2, the antenna 100 may be operated as a dual-resonance antenna, by adjusting a size of parameters of the CSRR slot 140 in a status that the impedance matching may have been achieved at the first-order resonance.

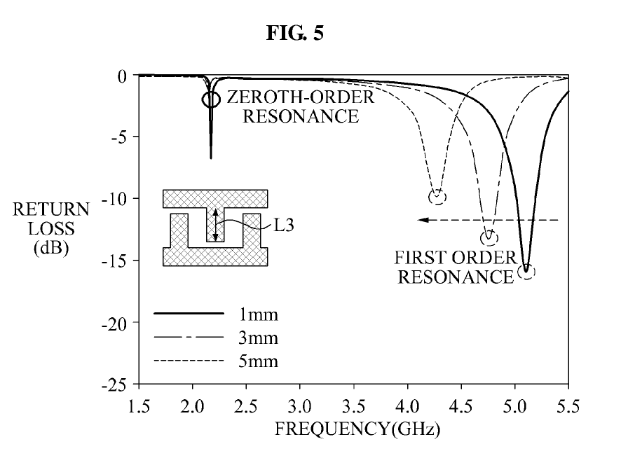

FIG. 5 illustrates an example of a change in a return loss of a microstrip patch antenna according to a change in a length of an interdigital capacitor.

Referring to FIG. 5, in the antenna 100, when a length L3 of the interdigital capacitor 130 is adjusted to optimally be 1 mm to 5 mm, series capacitance may be increased and accordingly a first-order resonance frequency may be reduced. Here, an operating frequency of the antenna 100 may be changed, and miniaturization of the antenna 100 may be achieved by changing the length of the interdigital capacitor 130 only, without changing an overall size of the antenna 100. In this instance, a zeroth-order resonance frequency may not be changed, however impedance matching may be damaged due to reduction of input impedance. In order to operate the antenna 100 in a dual band, the impedance may be matched at the zeroth-order resonance frequency by adjusting the size of the parameters of the CSRR slot 140.

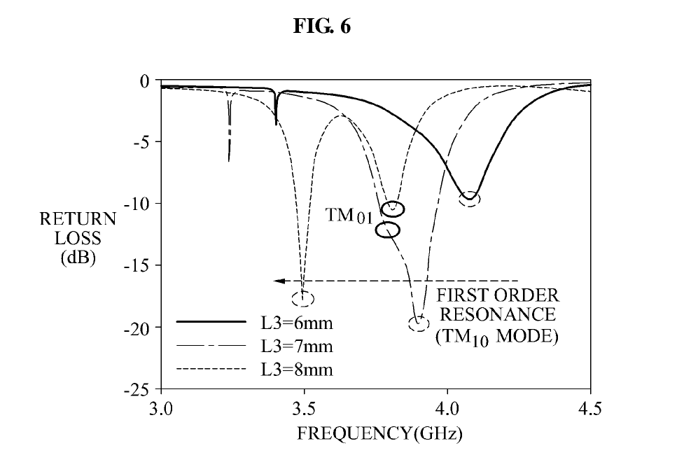

FIG. 6 illustrates another example of a change in a return loss of a microstrip patch antenna according to a change in a length of an interdigital capacitor.

As illustrated in FIG. 6, when the length L3 of the interdigital capacitor 130 is continuously increased, a first-order resonance frequency may be continuously reduced and an effect that a size of the antenna 100 may be reduced may be achieved. The first-order resonance frequency of the antenna may correspond to a TM₁₀ mode. However, when the length L3 of the interdigital capacitor 130 is greater than 7 mm, a TM₀₁ mode may be generated along with the TM₁₀ mode. In this instance, the TM₀₁ mode may be a mode in which an operating frequency may be determined based on the width W1 of the antenna 100, which may be different from a mode in which the operating frequency may be determined based on the length L1 of the antenna 100.

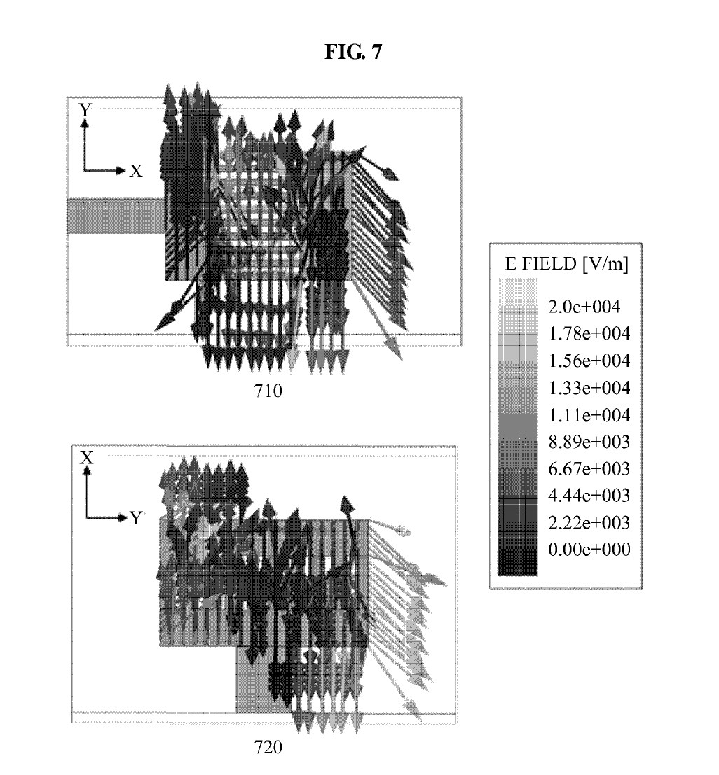

FIG. 7 illustrates electric field distribution of a microstrip patch antenna in modes, each having a different frequency.

As illustrated in a lower diagram 720 of FIG. 7, an electric field may have a half-wavelength resonance in a direction of a Y-axis, in a TM₀₁ mode. Accordingly, an operating frequency of the TM₀₁ mode may be adjusted by adjusting a width of the antenna 100. Conversely, the electric field may have a half-wavelength resonance in a direction of an X-axis, in a TM₁₀ mode in which a general patch antenna may be operated, as illustrated in an upper diagram 710 of FIG. 7.

The TM₁₀ mode and the TM₀₁ mode may be determined based on a direction of the antenna. For example, when the antenna is disposed in the direction of the X-axis, the TM₁₀ mode may be used, and when the antenna is disposed in the direction of the Y-axis, the TM₀₁ mode may be used. Accordingly, both the TM₁₀ mode and the TM₀₁ mode may be simultaneously used in a single antenna.

The diagrams 710 and 720 may illustrate the electric fields in the TM₁₀ mode and the TM₀₁ mode when the length L3 of the interdigital capacitor 130 corresponds to 8 mm The diagram 710 may indicate the electric field at 3.497 GHz corresponding to the first-order resonance frequency, and the diagram 720 may indicate the electric field at 3.812 GHz corresponding to the resonance frequency in the TM₀₁ mode.

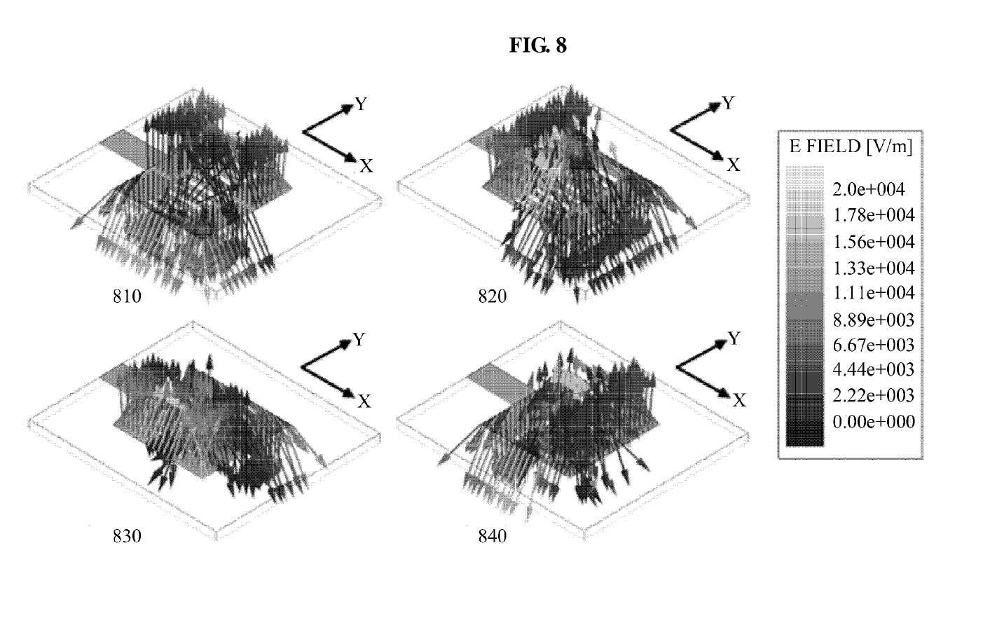

FIG. 8 illustrates electric field distribution in a hybrid mode where two modes may be combined, according to a change in input signal phase.

As illustrated in FIG. 8, when the length L3 of the interdigital capacitor 130 corresponds to 7 mm, there may be a hybrid mode in which a first-order resonance mode and a TM₀₁ mode may be combined in a band of 3.80 GHz. When the input signal phase corresponds to 0° and 180°, the TM₀₁ mode may occur as illustrated in diagrams 810 and 830 respectively. When the input signal phase corresponds to 90° and 270°, a TM₁₀ mode may occur as illustrated in diagrams 820 and 840 respectively. That is, when the length of the interdigital capacitor 130 is adjusted, the TM₁₀ mode and the TM₀₁ mode may form the hybrid mode, and the two modes may have a phase difference of 90° from each other, and accordingly may be operable without destructive interference from each other.

The patch 120 may combine the two modes, thereby extending the bandwidth of the antenna 100. An operating frequency of the TM₀₁ mode may be constant when the width of the antenna 100 is constant, and accordingly the bandwidth may be extendable when the hybrid mode is formed by properly adjusting the length L3 of the interdigital capacitor 130.

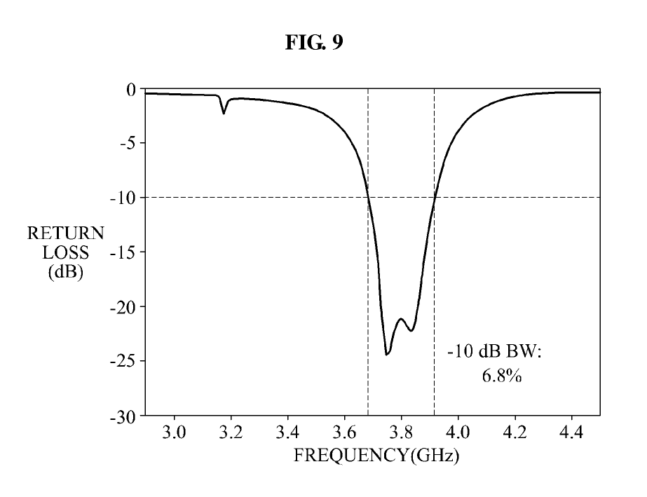

FIG. 9 illustrates a characteristic of a return loss of an optimized microstrip patch antenna.

Referring to FIG. 9, the length L3 of the interdigital capacitor 130 may correspond to 7.3 mm in order to extend a bandwidth of the antenna 100 up to a maximum width. In this instance, a characteristic of the return loss of the antenna 100 may be the same as described with respect to FIG. 8.

The bandwidth of a 10 dB return loss of the antenna 100 may correspond to 6.8%, and may be expendable to be three times greater than an existing patch antenna. Also, a physical size of the antenna 100 may correspond to 0.24 λ₀×0.24 λ₀×0.02 λ₀ at a central operating frequency, and the antenna 100 may have a size reduced by 55% when compared to a microstrip patch antenna designed at the same frequency on the same substrate.

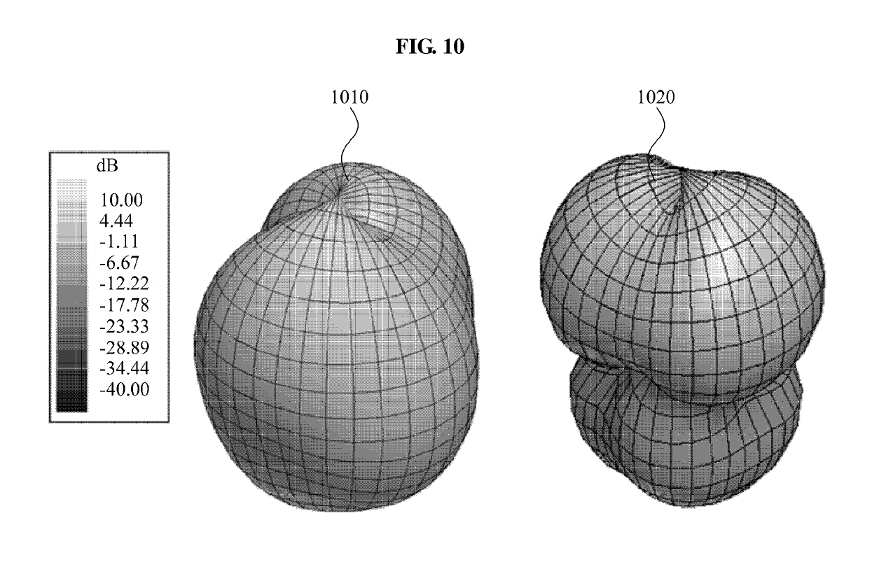

FIG. 10 illustrates three-dimensional (3D) radiation patterns of a microstrip patch antenna.

Referring to FIG. 10, the antenna 100 may have a near-isotropic radiation pattern 1010 with respect to a horizontally polarized wave. Also, with respect to a vertically polarized wave, the antenna 100 may have a directional radiation pattern 1020 in a direction of a ±z-axis, and may be null with respect to all directions on an x-y plane.

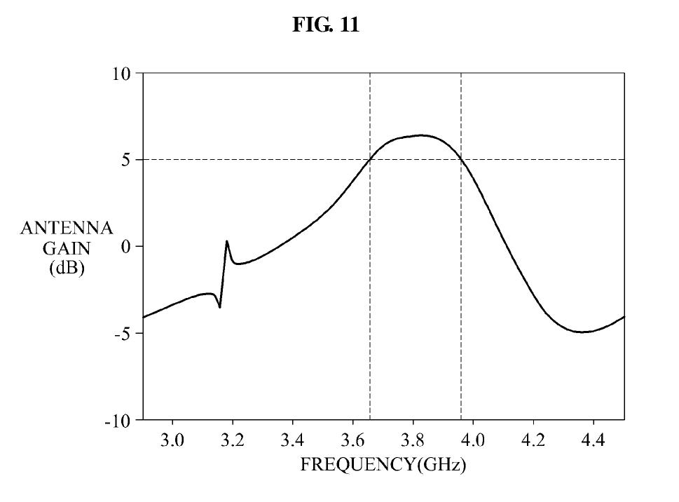

FIG. 11 illustrates a gain characteristic of a microstrip patch antenna.

Referring to FIG. 11, the antenna 100 may have a gain greater than 5 dB within a range of an operating frequency, and may have a maximum gain of 6.4 dB. In spite of its miniaturized size, the antenna 100 may have the same electrical length due to a characteristic of a metamaterial, and thus, may enable maintaining a high gain.

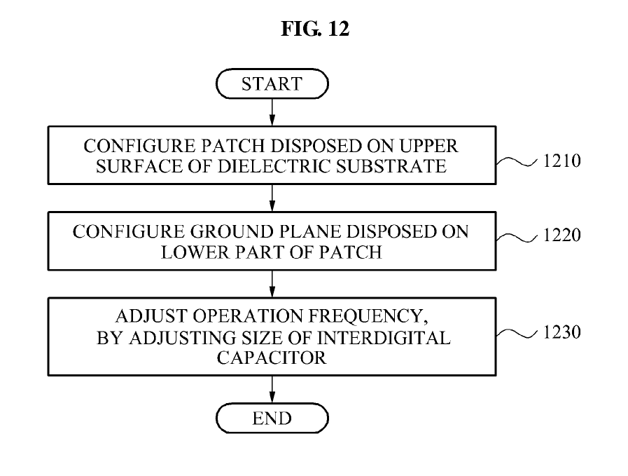

FIG. 12 illustrates a sequence of a method of operating a microstrip patch antenna according to an embodiment of the present invention.

Referring to FIG. 12, the antenna 100 may configure the patch 120 disposed on an upper surface of a dielectric substrate, including the interdigital capacitor 130 and the microstrip feed line 110, in operation 1210.

In operation 1220, the antenna 100 may configure the ground plane 150 disposed on a lower part of the patch 120, including the CSRR slot 140.

In operation 1230, the antenna 100 may adjust an operating frequency by adjusting a size of the interdigital capacitor 130. That is, in operation 1230, the operating frequency of the antenna 100, for example, a first-order resonance frequency may be adjusted, and a TM₀₁ mode may be additionally applied. The size of the interdigital capacitor 130 may be adjusted in a state that the size of the antenna 100 may be fixed.

As an embodiment of the present invention, the antenna 100 may be controlled to be operated in a dual band, by adjusting the length L3 of the interdigital capacitor 130, or a size with respect to any of the radius R2, the width W2, the ring gap D2, and the ring split G2 of the CSRR slot 140.

As another embodiment of the present invention, the antenna 100 may apply the TM₀₁ mode, by adjusting the length L3 of the interdigital capacitor 130.

As still another embodiment of the present invention, the antenna 100 may combine two modes, for example, a TM₁₀ mode and the TM₀₁ mode, each having a different frequency, by adjusting the length L3 of the interdigital capacitor 130. The antenna 100 may extend a bandwidth of the antenna 100, through the combination of the two modes. Also, the antenna 100 may enable having a near-isotropic radiation pattern with respect to a horizontally polarized wave, through the combination of the two modes.

The aforementioned methods may be recorded, stored, or fixed in one or more non-transitory computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A microstrip patch antenna, comprising:
a patch disposed on an upper surface of a dielectric substrate, the patch comprising an interdigital capacitor; and
a ground plane disposed on a lower part of the patch, the ground plane comprising a complementary split-ring resonator (CSRR) slot.

2. The microstrip patch antenna of claim 1, wherein the patch further comprises a microstrip feed line.

3. The microstrip patch antenna of claim 1, wherein the patch adjusts an electrical size of the microstrip patch antenna, by adjusting a length of the interdigital capacitor.

4. The microstrip patch antenna of claim 1, wherein the CSRR slot adjusts an operating frequency of the microstrip patch antenna, by adjusting a size with respect to any of a radius, a width, a ring gap, and a ring split.

5. The microstrip patch antenna of claim 1, wherein the CSRR slot matches zeroth-order resonance impedance, by adjusting a size with respect to any of a radius, a width, a ring gap, and a ring split.

6. The microstrip patch antenna of claim 1, wherein the microstrip patch antenna is controlled to be operated in a dual band, by adjusting a length of the interdigital capacitor, or a size with respect to any of a radius, a width, a ring gap, and a ring split of the CSRR slot.

7. The microstrip patch antenna of claim 1, wherein the microstrip patch antenna matches impedance by adjusting a size of the patch.

8. The microstrip patch antenna of claim 1, wherein the patch applies both TM₀₁ and TM₁₀ mode simultaneously to the microstrip patch antenna, by adjusting a length of the interdigital capacitor.

9. The microstrip patch antenna of claim 1, wherein the patch combines two modes, each having a different frequency, by adjusting a length of the interdigital capacitor.

10. The microstrip patch antenna of claim 9, wherein the patch extends a bandwidth of the microstrip patch antenna, through the combination of the two modes.

11. The microstrip patch antenna of claim 9, wherein the patch enables the microstrip patch antenna to have an near-isotropic radiation pattern with respect to a horizontally polarized wave, through the combination of the two modes.

12. A method of operating a microstrip patch antenna, the method comprising:
configuring a patch disposed on an upper surface of a dielectric substrate, comprising an interdigital capacitor and a microstrip feed line; and
configuring a ground plane disposed on a lower part of the patch, comprising a complementary split-ring resonator (CSRR) slot.

13. The method of claim 12, further comprising:
adjusting an electrical size of the microstrip patch antenna, by adjusting a length of the interdigital capacitor.

14. The method of claim 12, further comprising:
adjusting an operating frequency of the microstrip patch antenna, by adjusting a size with respect to any of a radius, a width, a ring gap, and a ring split of the CSRR slot.

15. The method of claim 12, further comprising:
matching zeroth-order resonance impedance, by adjusting a size with respect to any of a radius, a width, a ring gap, and a ring split of the CSRR slot.

16. The method of claim 12, further comprising:
controlling the microstrip patch antenna to be operated in a dual band, by adjusting a length of the interdigital capacitor, or a size with respect to any of a radius, a width, a ring gap, and a ring split of the CSRR slot.

17. The method of claim 12, further comprising:
applying both TM₀₁ and TM₁₀ mode simultaneously to the microstrip patch antenna, by adjusting a length of the interdigital capacitor.

18. The method of claim 12, further comprising:
combining two modes, each having a different frequency, by adjusting a length of the interdigital capacitor.

19. The method of claim 18, further comprising:
extending a bandwidth of the microstrip patch antenna, through the combination of the two modes.

20. The method of claim 18, further comprising:
enabling the microstrip patch antenna to have an near-isotropic radiation pattern with respect to a horizontally polarized wave, through the combination of the two modes.
